(19) United States
(12) Patent Application Publication
(10) Pub. No.: US 2014/0125143 A1
(43) Pub. Date: May 8, 2014

(54) RESONATOR AND WIRELESS POWER TRANSMISSION DEVICE

(71) Applicant: KABUSHIKI KAISHA TOSHIBA, Tokyo (JP)

(72) Inventors: Akiko YAMADA, Yokohama-Shi (JP); Tetsu SHIJO, Tokyo (JP); Shuichi OBAYASHI, Yokohama-Shi (JP)

(73) Assignee: KABUSHIKI KAISHA TOSHIBA, Tokyo (JP)

(21) Appl. No.: 14/069,986

(22) Filed: Nov. 1, 2013

(30) Foreign Application Priority Data
Nov. 8, 2012 (JP) 2012-246285

(51) Int. Cl. H01F 38/14

(52) U.S. Cl. CPC H01F 38/14
USPC 307/104; 336/212; 336/90

(57) ABSTRACT

According to one embodiment, there is provided a first magnetic core, a coil and a second magnetic core. The first magnetic core includes a first magnetic core including a plurality of first core portions which are arranged with a gap to each other. The coil is wound around the first magnetic core. The second magnetic core includes at least a second core portion which is arranged in the gap between the first core portions or arranged so as to face the gap. A magnetic reluctance of the first magnetic core is lower than a magnetic reluctance of the second magnetic core.

### CROSS REFERENCE TO RELATED APPLICATIONS

This application is based upon and claims the benefit of priority from the prior Japanese Patent Application No. 2012-246285, filed on Nov. 8, 2012, the entire contents of which are incorporated herein by reference.

### FIELD

Embodiments described herein relates to a resonator and a wireless power transmission device.

### BACKGROUND

A power transmission apparatus of related art has a configuration in which a primary resonator and a secondary resonator which have a substantially flat magnetic core wound with a coil are opposite to each other to be resistant to a positional shift of a primary side coil and a secondary side coil in a horizontal direction which is parallel to a winding direction of the coils. However, this undesirably caused an area of the core to be extended in a planar view, increasing a weight thereof.

In order to solve the above defects concerning the weight, a wireless power transmission device of related art has a configuration in which each magnetic core for a coil is provided as a plurality of cores arranged with gaps for weight reduction. Since magnetic field lines are output from the plural cores to fill gaps between the cores, a primary side core and a secondary side core serve as a core having a size expanded including the gaps between the cores.

However, a magnetic flux concentrates at the cores at horizontal both ends of the plural cores most on portions wound with the coil. For this reason, this configuration has a problem that if the core is simply divided, a cross sectional area practically becomes small and a concentration degree is deteriorated and a core loss increases. The increase of the core loss is caused for a reason described below.

Generally, the core loss, that is, a loss in the case where a magnetic body is used as a core in an alternating current magnetic field is classified into a hysteresis loss, an eddy-current loss and other residual losses. According to a Steinmetz's empirical formula, the hysteresis loss is proportional to the 1.6th power of a magnetic flux density B in a range of the magnetic flux density B from about 0.1 to 1 tesla. Also, the eddy-current loss is proportional to the square of the magnetic flux density B. Note that it is known that other residual losses increase in frequencies of MHz or more. Therefore, for example, in the case where a frequency of 1 MHz or less is used, other residual losses can be approximately estimated as much smaller than the hysteresis loss and the eddy-current loss.

As described above, the wireless power transmission device of related art has had a problem that the resonator with the coil wound using the substantially flat magnetic core becomes weighted. Additionally, there has been a problem that the use of the magnetic core having a plurality of cores arranged with gaps for weight reduction causes the most concentration of magnetic flux at the cores at horizontal both ends on the portions wound with the coil, deteriorating the concentration degree and increasing the core loss.

Besides, there have been objects of achieving size reduction, lowered loss, thickness reduction, weight reduction of entire apparatus, simplified heat dissipation mechanism, increased electric power, loss reduction and the like.

### BRIEF DESCRIPTION OF THE DRAWINGS

FIG. 1 illustrates a first example of a resonator according to an embodiment;

FIG. 2 schematically illustrates an intensity of magnetic flux distribution in the configuration of FIG. 1 in regions;

FIG. 3 illustrates a second example of a resonator according to an embodiment;

FIG. 4 schematically illustrates an intensity of magnetic flux distribution in the configuration of FIG. 3 in regions;

FIG. 5 illustrates a resonator in which a second magnetic core is configured to include a dielectric substrate and a ferrite film;

FIG. 6 illustrates a resonator in which the second magnetic core is adhered to a bottom surface of a housing;

FIG. 7 illustrates modified examples of the second configuration example in FIG. 3;

FIG. 8 illustrates a third example of a resonator according to an embodiment;

FIG. 9 is a block diagram of a wireless power transmission device according to an embodiment;

FIG. 10 illustrates a simulation result obtained by plotting a loss resistance owing to a core loss with respect to an input current;

FIG. 11 illustrates plural examples of resonators used in the simulation of FIG. 10;

FIG. 12 illustrates a simulation result obtained by calculating a coupling coefficient in a case of using each of the resonators in FIG. 11; and

FIG. 13 illustrates a result example of calculating a magnetic flux density distribution.

### DETAILED DESCRIPTION

According to one embodiment, there is provided a first magnetic core, a coil and a second magnetic core.

The first magnetic core includes a plurality of first core portions which are arranged with a gap to each other.

The coil is wound around the first magnetic core.

The second magnetic core includes at least a second core portion which is arranged in the gap between the first core portions or arranged so as to face the gap.

A magnetic reluctance of the first magnetic core is lower than a magnetic reluctance of the second magnetic core.

Hereinafter, embodiments are described in detail with referring to the drawings.

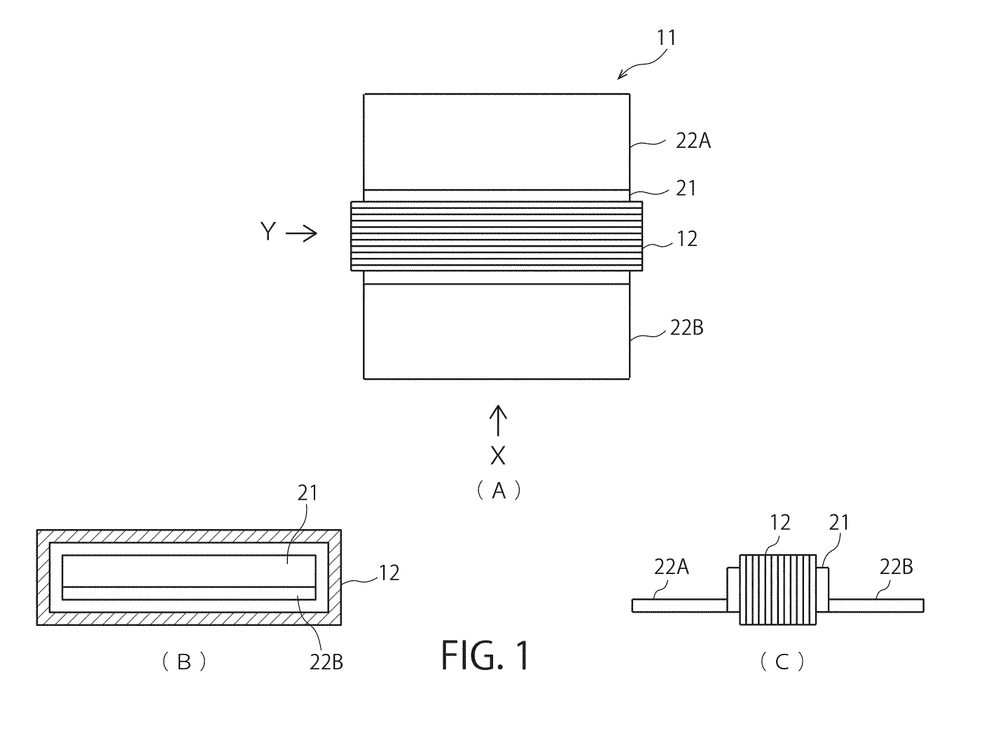

FIG. 1 illustrates a first configuration example of a resonator according to an embodiment. FIG. 1(A) is a plan view, FIG. 1(B) is a front view seen from a direction X, and FIG. 1(C) is a side view seen from a direction Y.

This resonator characteristically uses a magnetic member which has a low magnetic reluctivity in a magnetic flux concentrated region, and high magnetic reluctivity in other regions. This allows a high transmitting efficiency to be maintained and a weight to be reduced.

The resonator in FIG. 1(A) to (C) includes a magnetic core block 11, and a coil 12 wound around the magnetic core block 11.

The magnetic core block 11 has a first magnetic core 21 and a second magnetic core 22 (22A and 22B). The second magnetic core 22 includes two core portions 22A and 22B.

The core portions 22A and 22B of the second magnetic core 22 are arranged on both sides of the first magnetic core 21 along a first direction (vertically in a paper surface) as shown in FIG. 1(A). The coil 12 is wound around an entire or a part of the first magnetic core 21 along the first direction. The coil 12 may be wound around a part of the second magnetic core 22 as well.

A magnetic reluctance of the first magnetic core 21 is lower than a magnetic reluctance of the second magnetic core 22. A lateral width of the second magnetic core 22 (core portions 22A and 22B) is substantially the same as that of the first magnetic core 21. A thickness of the second magnetic core 22 is thinner than that of the first magnetic core 21. However, the lateral width of the second magnetic core 22 (core portions 22A and 22B) may be different from that of the first magnetic core 21. Additionally, so long as the magnetic reluctance of the first magnetic core 21 is lower than the magnetic reluctance of the second magnetic core 22, a configuration may be adopted in which the thickness of the second magnetic core 22 is the same as or thicker than that of the first magnetic core 21.

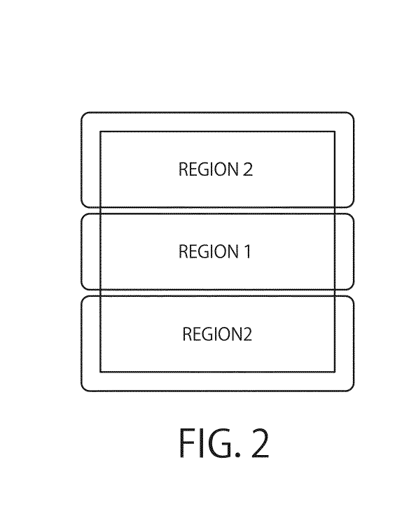

FIG. 2 schematically illustrates an intensity of magnetic flux distribution in the configuration of FIG. 1(A) to (C) in regions. A region 1 is a portion of an intense magnetic flux, and a region 2 is a portion of a weak magnetic flux. In the configuration of FIG. 1(A) to (C), principally the first magnetic core is arranged in an area corresponding to the region 1, and the second magnetic core having the magnetic reluctance higher than the first magnetic core is arranged in an area corresponding to the region 2. This allows the high transmitting efficiency to be maintained and the weight to be reduced as a whole. A reason why these effects are obtained will be described later.

A configuration example of the second magnetic core 22 will be described below.

The second magnetic core 22 is configured using the same material as the first magnetic core, and may be configured to be thinner than the first magnetic core. The second magnetic core 22 is configured to be thinner than the first magnetic core 21 to have the magnetic reluctance higher than the first magnetic core 21. As a result, a weight of the resonator can be reduced. The second magnetic core 22 may be configured using the same material as the first magnetic core 21 or a magnetic body different in composition.

Further, the second magnetic core 22 may be formed of a magnetic material different from that of the first magnetic core 21. For example, the second magnetic core 22 may be formed of a magnetic material smaller in specific gravity than the first magnetic core 21. The second magnetic core 22 is formed of a magnetic material smaller in specific gravity than the first magnetic core 21 to have the magnetic reluctance higher than the first magnetic core 21. As result, a weight of the resonator can be reduced. As a technique to reduce the specific gravity, the second magnetic core 22 may be formed of mixture of the magnetic material and a material different from the magnetic material. At this time, the relevant material different from the magnetic material may include a dielectric material such as a resinous material, for example. This allows the intensity of the second magnetic core 22 to be increased.

Furthermore, the second magnetic core 22 may be formed of a dielectric substrate and a magnetic film arranged on a surface of the dielectric substrate. This allows the intensity of the second magnetic core 22 to be increased. The magnetic film may be, for example, a ferrite film or a magnetic sheet.

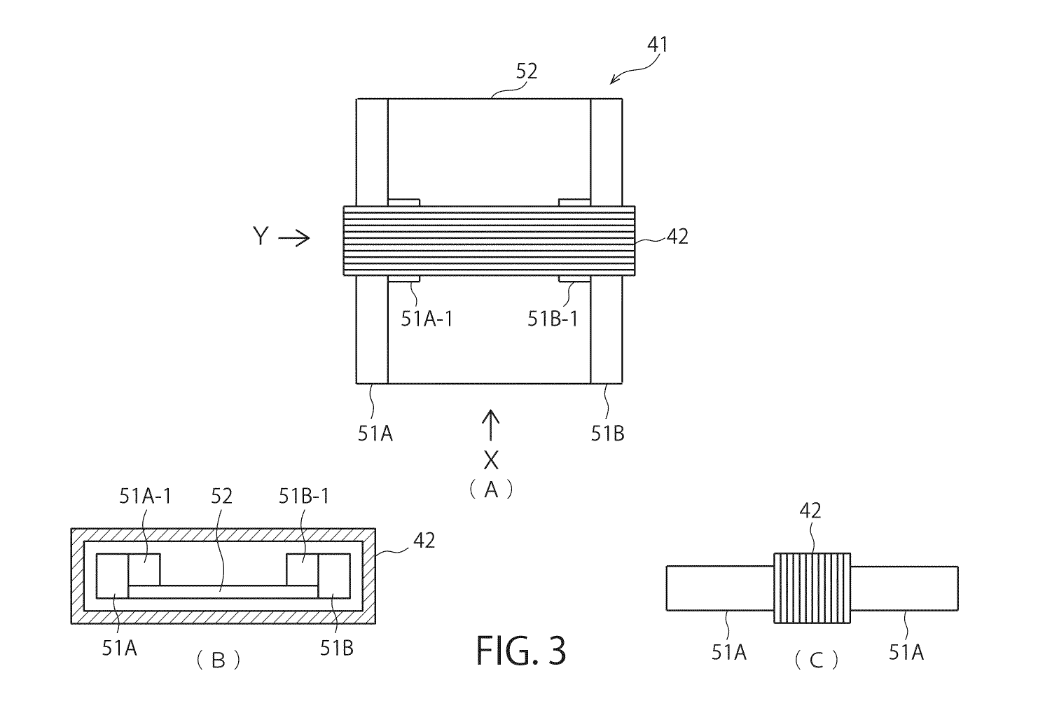

FIG. 3 illustrates a second configuration example of a resonator according to an embodiment. FIG. 3(A) is a plan view, FIG. 3(B) is a front view seen from a direction X, and FIG. (C) is a side view seen from a direction Y.

A magnetic core block 41 has a first magnetic core 51 and a second magnetic core 52. The first magnetic core 51 includes two core portions 51A and 51B. The core portions 51A and 51B are arranged with a gap to each other.

A coil 42 is wound around the first magnetic core 51. The core portions 51A and 51B having portions wound with the coil 42, on which portions the magnetic flux is concentrated, have extension parts 51A-1 and 51B-1 along the paper surface, respectively. The extension parts 51A-1 and 51B-1 are a part of the core portions 51A and 51B, respectively. This allows a larger cross section area of the core at the portion on which the magnetic flux is concentrated. The coil 42 is wound around the first magnetic core 51 so as to envelop the extension parts 51A-1 and 51B-1.

The second magnetic core 52 is arranged in the gap between the core portions 51A and 51B.

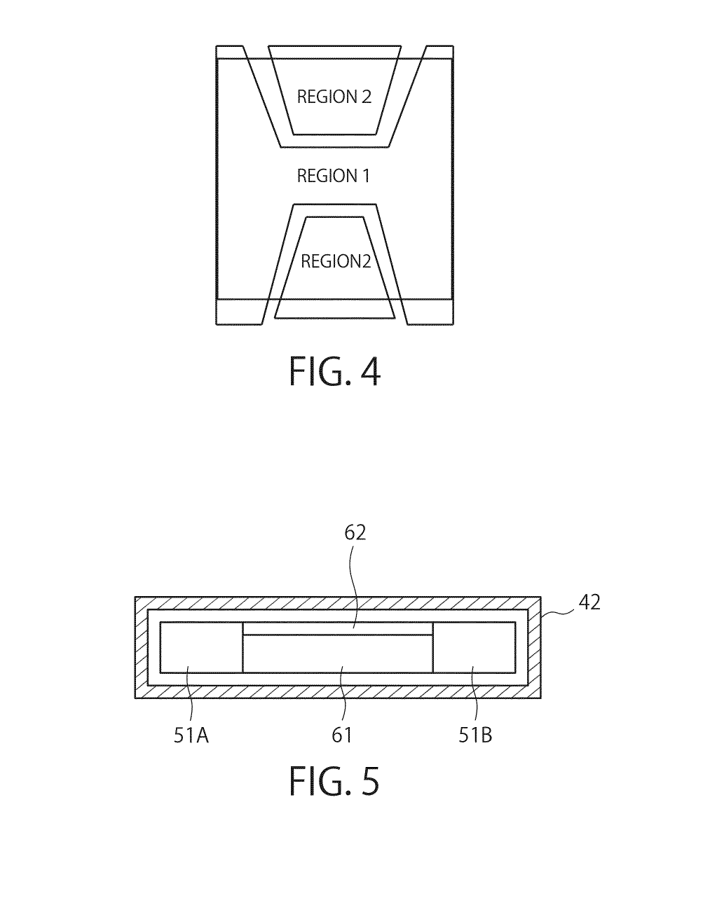

FIG. 4 schematically illustrates an intensity of magnetic flux distribution in the configuration of FIG. 3 in regions. A region 1 is a portion of an intense magnetic flux, and a region 2 is a portion of a weak magnetic flux. In the configuration of FIG. 3, principally the first magnetic cores 51A and 51B are arranged in an area corresponding to the region 1, and the second magnetic core 52 is arranged in an area corresponding to the region 2. However, a part of the region 1 (part between the extension parts 51A-1 and 51B-1) is arranged with the second magnetic core 52 for placing priority on weight reduction.

Similarly to the first configuration example, a magnetic reluctance of the first magnetic core 51 is lower than a magnetic reluctance of the second magnetic core 52. The second magnetic core 52 can be formed similarly to the specific example shown in the first configuration example.

FIG. 5 illustrates a configuration of a resonator in a case where the second magnetic core 52 is configured to include a dielectric substrate 61 and a ferrite film 62. Since the ferrite film 62 is fragile, the intensity thereof can be improved by being adhered to the dielectric substrate 61. The magnetic sheet may be used instead of the ferrite film 62. In addition, a substrate may be made of mixture of a resinous material such as rubber and a magnetic material to be used as the second magnetic core. This also can improve the intensity of the second magnetic core 52.

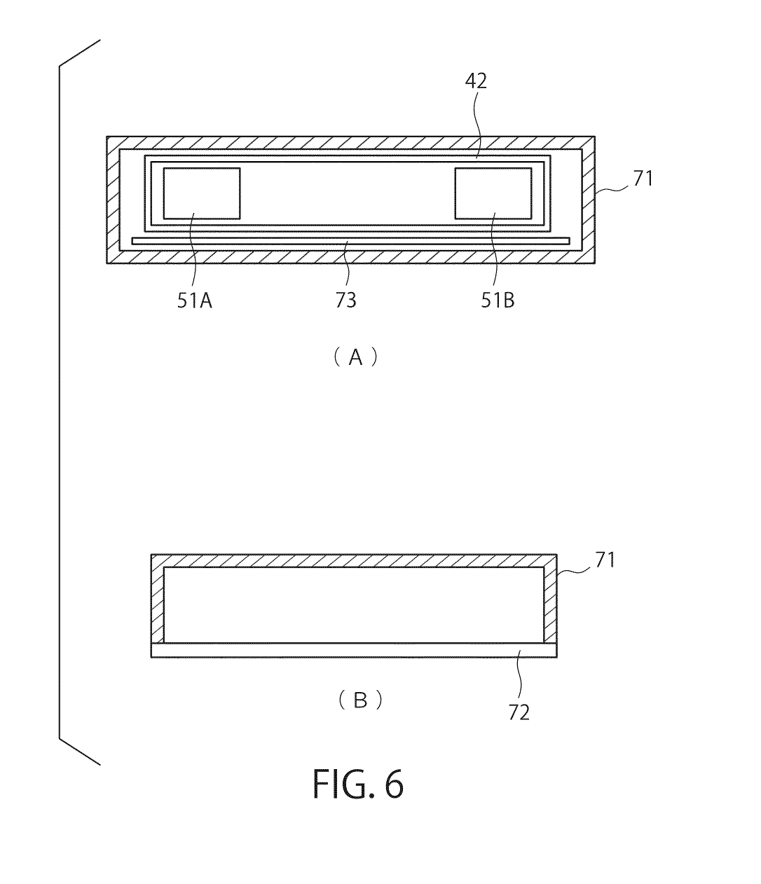

FIG. 6(A) illustrate a configuration of a resonator in which a second magnetic core 73 is adhered to an inner surface (here, bottom surface) of a housing 71. The housing 71 is formed of dielectrics, for example. As shown in FIG. 6(B), a part of the housing (e.g., bottom surface) may be formed of a metal plate 72 of aluminum, copper or the like, on which the second magnetic core 73 may be arranged.

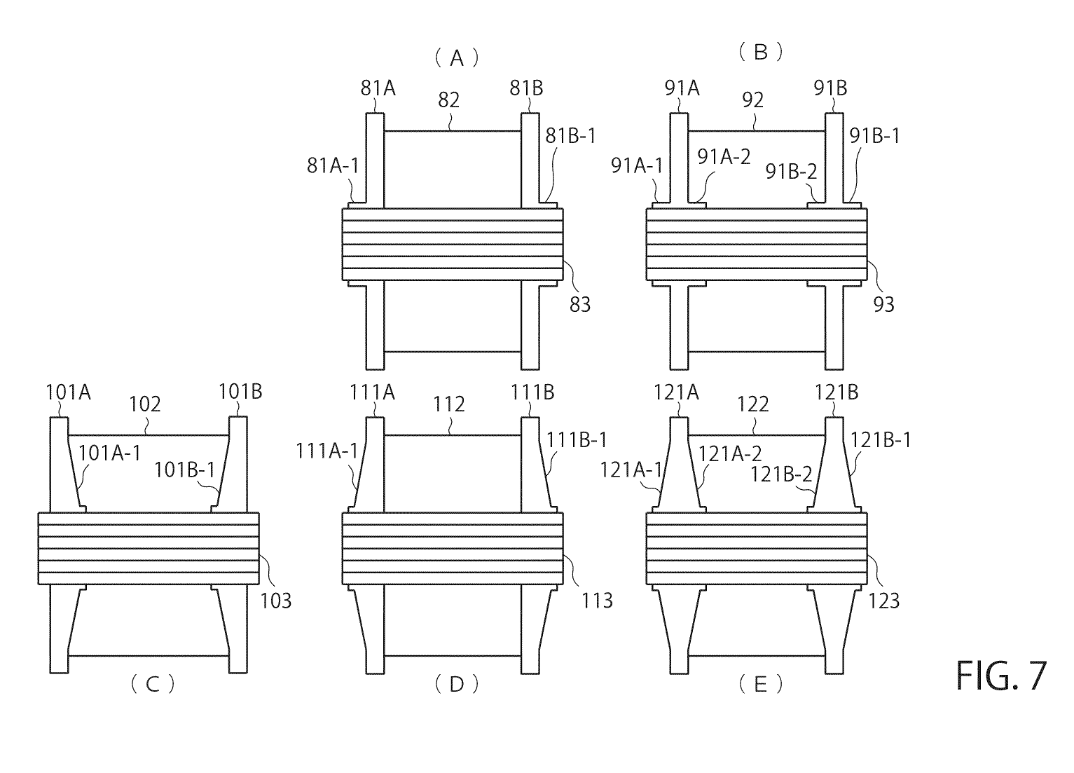

FIG. 7(A) to (E) illustrate six modified examples of the second configuration example in FIG. 3. Each of modified examples shows only a plan view. Front views and side views are not shown because they can be easily appreciated from FIG. 3.

FIG. 7(A) illustrates a first modified example. Core portions 81A and 81B of the first magnetic core have at centers thereof extension parts 81A-1 and 81B-1 provided, respectively, in a direction (outward) opposite to a direction in which the core portions face. Numeral 82 indicates a second magnetic core, and 83 indicates a coil.

FIG. 7(B) illustrates a second modified example. In this example, core portions 91A and 91B have at both insides and outsides thereof extension parts 91A-1 and 91A-2, and 91B-1 and 91B-2 provided, respectively. Numeral 92 indicates a second magnetic core, and 93 indicates a coil.

FIG. 7(C) illustrates a third modified example. In this example, core portions 101A and 101B have at insides thereof extension parts 101A and 101B provided, respectively. The extension parts 101A and 101B each have a shape wider toward the center of the core portion. Numeral 102 indicates a second magnetic core, and 103 indicates a coil.

FIG. 7(D) illustrates a fourth modified example. In this example, core portions 111A and 111B have at outsides thereof extension parts 111A-1 and 1118-1 provided, respectively. The extension parts 111A-1 and 111B-1 each have a shape wider toward the center of the core portion.

FIG. 7(E) illustrates a fifth modified example. In this example, core portions 121A and 121B have at both insides and outsides thereof extension parts 121A-1 and 121A-2, and 121B-1 and 121B-2 provided, respectively. The extension parts each have a shape wider toward the center. Numeral 122 indicates a second magnetic core, and 123 indicates a coil.

In the configurations shown in FIG. 3, and FIG. 7(A) to (E), the first magnetic core is formed using two core portions arranged with gap, but may be formed using three core portions or more. At this time, the second magnetic cores may be formed using a plurality of core portions, and the core portions of the second magnetic core may be arranged in gaps between the core portions of the first magnetic core or arranged so as to face the gaps.

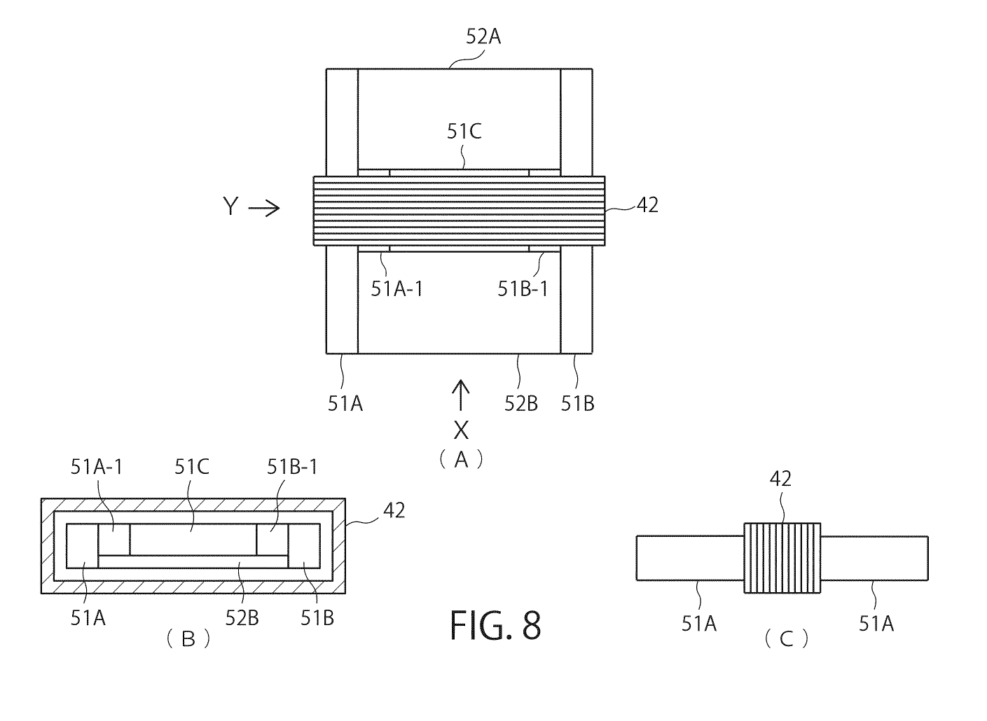

FIG. 8 illustrates a third configuration example of a resonator according to an embodiment. FIG. 8(A) is a plan view, FIG. 8(B) is a front view seen from a direction X, and FIG. 8(C) is a side view seen from a direction Y.

The drawings are different from FIG. 3 in that the first magnetic core further includes a core portion 51C between the extension part 51A-1 of the core portion 51A and the extension part 51B-1 of the core portion 51B. The second magnetic core (core portions 52A and 52B) is arranged in, of the gaps between the core portions 51A and 51B, at least a portion where the core portion 51C is not arranged. Note that in the example shown in the figure, the core portion 51C has the thickness and the magnetic reluctance the same as the core portion 51A and the extension part 51A-1. A configuration may be adopted in which, but heavier in weight than the configuration of FIG. 3(A) to (C), a cross section area of a portion on which the magnetic flux is concentrated may be made larger to increase the transmitting efficiency. The second magnetic core is divided into the core portions 52A and 52B via the core portion 51C. The coil 42 is wound so as to envelop the core portion 51C.

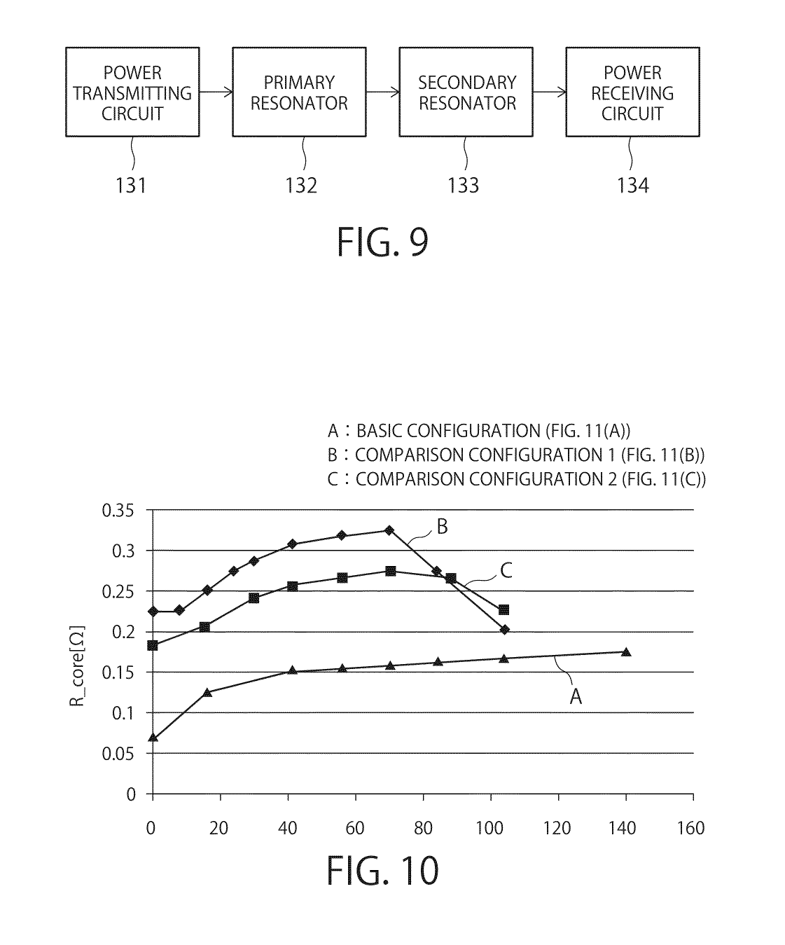

FIG. 9 illustrates a block diagram of a wireless power transmission device according to an embodiment. When wireless power transmission is carried out, a primary resonator 132 and a secondary resonator 133 faced with each other are magnetically coupled to each other to transmit the power. As each of the primary resonator and the secondary resonator, the resonator shown in FIG. 1, FIG. 3, FIG. 7, FIG. 8 and the like can be used.

A power transmitting circuit 131 supplies an electrical power signal having a frequency with which the primary resonator 132 can perform efficient transmission. Coupling of the primary resonator 132 and the secondary resonator 133 allows the electrical power signal to be wirelessly transmitted. The electrical power signal the secondary resonator 133 receives is sent to a power receiving circuit 134. Here, as necessary, a controlling unit of power transmitting circuit 131 and a controlling unit of power receiving circuit 134 communicate to each other using a wireless signal between the power transmitting circuit 131 and the power receiving circuit 134 in order to start, end and stop sending/receiving of power, change an amount of transmission power and the like.

The description is given below of how the present inventor has reached an idea of the embodiment.

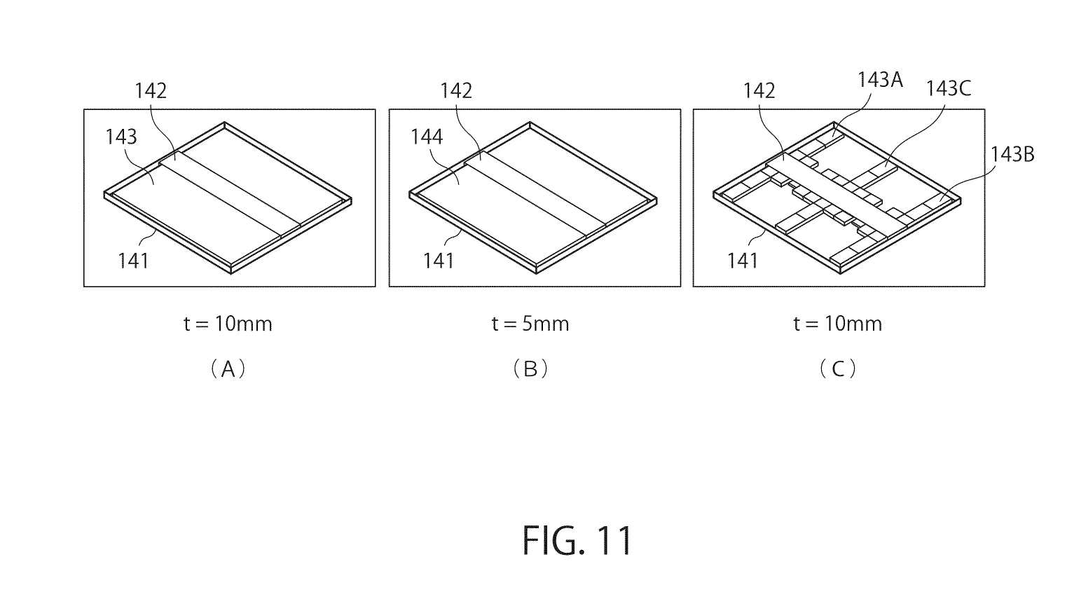

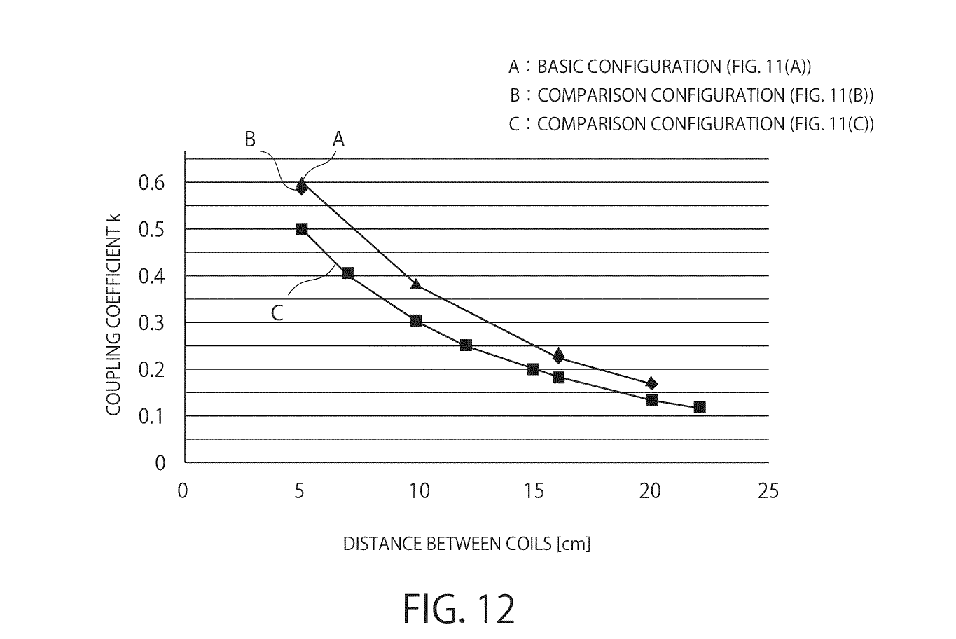

FIG. 10 illustrates a simulation result obtained by plotting a loss resistance owing to a core loss with respect to an input current. In the simulation, resonator configurations shown in FIG. 11(A), FIG. 11(B), and FIG. 11(C) were used. Each of the resonators of FIG. 11(A) to (C) is arranged on an aluminum case 141.

FIG. 11(A) shows a configuration in which the magnetic core has a thickness of “t”=10 mm, and is uniformly arranged on the entire surface (basic configuration). A magnetic core 143 is wound with a coil 142.

FIG. 11(B) shows a magnetic core 144 having a thickness of “t”=5 mm which is half the thickness of the magnetic core 143 in FIG. 11(A). Other points than this are similar to those of FIG. 11(A).

FIG. 11(C) shows the magnetic cores 143 (143A, 143B and 143C) having a thickness of “t”=10 mm, similarly to FIG. 11(A), but the core is ingeniously arranged. That is, three core portions 143A, 143B, and 143C are arranged with gaps to form the magnetic core. A weight of each of the configurations in FIG. 11(B) and FIG. 11(C) is about half the configuration in FIG. 11(A). In FIG. 11(C), the second magnetic core as shown in FIG. 3(A) to (C) or the like is not arranged in the gaps between the core portions.

The simulation results with respect to FIG. 11(A) and FIG. 11(B), when compared with each other, show that as the thickness of the magnetic core is simply made thinner, the magnetic reluctance increases, increasing a loss in a core magnetic body.

On the other hand, in the configuration (FIG. 11(C)) in which the core is mainly arranged on a portion on which the magnetic flux is concentrated, and the core is not arranged on a portion having small magnetic flux density, the core loss can be more suppressed as compared to the configuration in which the thickness is simply made half.

Next, FIG. 12 illustrates a simulation result obtained by calculating a coupling coefficient in a case of using each of three resonators in FIG. 11(A) to 11(C).

It is found that regardless of the thickness of the magnetic core, the coupling coefficient is high in the case of arranging the magnetic core on the entire surface rather than the case of arranging the plural core portions with gaps (or rather than thinning out the core). That is, it is appreciated that even if the thickness of the magnetic core is made thinner, no effect or limited effect is given on the coupling coefficient.

From the simulation results in FIG. 12, a surface area of the magnetic core is preferably increased in order to obtain high coupling coefficient value. Additionally, from the simulation result in FIG. 10, lowering the magnetic reluctance in a portion on which the magnetic flux is more concentrated can suppress rise of the core loss. The wireless power transmitting efficiency is defined by a product of a coupling coefficient “K” between the resonators and Q-factor (ωL/R) of the resonator. Therefore, the present inventor has reached an idea of the resonator configuration in which the area of the magnetic core is increased, and the magnetic reluctance is heightened in a portion on which the magnetic flux is less concentrated (weight reduction) such that reduction of the coupling coefficient and rise of the core loss are suppressed to reduce the entire weight.

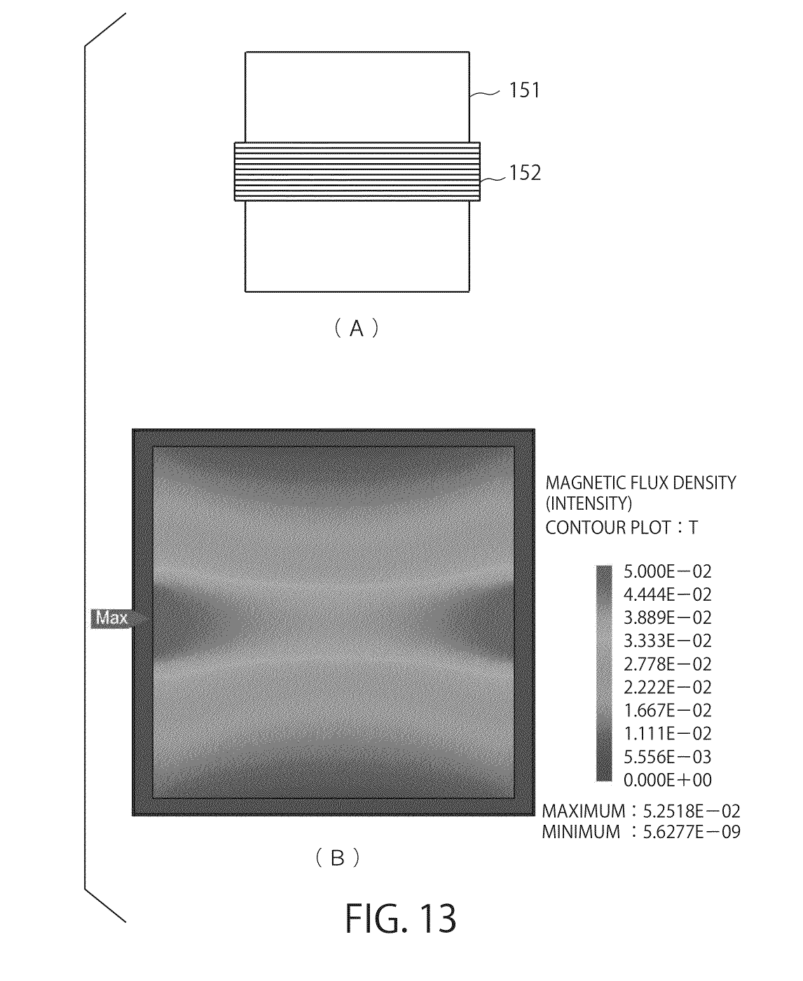

FIG. 13(B) illustrates a result example of calculating a magnetic flux density distribution in the resonator configuration shown in FIG. 13(A). A resonator in FIG. 13(A) has a magnetic core 151 wound with a coil 152, and has a configuration similar to FIG. 11(A) or FIG. 11(B).

As shown in FIG. 13(B), the magnetic flux density immediately under the coil winding is the most intense. The more toward the ends, the lower the magnetic flux density. Thus, as described above, the region is divided correspondingly to the magnetic flux density distribution, the magnetic reluctance is lowered in the region on which the magnetic flux is concentrated, and the magnetic reluctance is heightened in other regions (weight reduction). This can achieve the high efficient transmission (suppressing reduction of the coupling coefficient, suppressing rise of the core loss) as well as weight reduction.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A resonator, comprising:
a first magnetic core including a plurality of first core portions which are arranged with a gap to each other;
a coil which is wound around the first magnetic core; and
a second magnetic core including at least a second core portion which is arranged in the gap between the first core portions or arranged so as to face the gap,
wherein a magnetic reluctance of the first magnetic core is lower than a magnetic reluctance of the second magnetic core.

2. The resonator according to claim 1, wherein the first magnetic core further includes a third core portion arranged in a part of the gap between the first core portions, and
the first core portions and the third core portion are integrally formed as a whole,
the third core portion is wound with the coil as well as the first core portion, and
the second core portion is arranged in a part of the gap between the first core portions, the part is different from the part where the third core portion is arranged, or the second core portion is arranged so as to face the different part.

3. A resonator, comprising:
a first magnetic core;
a second magnetic core including core portions arranged on sides of the first magnetic core; and
a coil which is wound around the first magnetic core,
wherein a magnetic reluctance of the first magnetic core is lower than a magnetic reluctance of the second magnetic core.

4. The resonator according to claim 1, wherein the second magnetic core is formed of a magnetic material smaller in specific gravity than the first magnetic core.

5. The resonator according to claim 1, wherein the second magnetic core includes a dielectric substrate and a magnetic film arranged on a surface of the dielectric substrate.

6. The resonator according to claim 1, wherein the second magnetic core is arranged on an inner surface of a housing.

7. The resonator according to claim 1, wherein the second magnetic core has a thickness thinner than the first magnetic core.

8. The resonator according to claim 1, wherein the second magnetic core is formed of mixture of a magnetic material and a dielectric material.

9. The resonator according to claim 3, wherein the second magnetic core is formed of a magnetic material smaller in specific gravity than the first magnetic core.

10. The resonator according to claim 3, wherein the second magnetic core includes a dielectric substrate and a magnetic film arranged on a surface of the dielectric substrate.

11. The resonator according to claim 3, wherein the second magnetic core is arranged on an inner surface of a housing.

12. The resonator according to claim 3, wherein the second magnetic core has a thickness thinner than the first magnetic core.

13. The resonator according to claim 3, wherein the second magnetic core is formed of mixture of a magnetic material and a dielectric material.

14. A wireless power transmission device, comprising:
a primary resonator according to claim 1 configured to receive an alternating-current signal from a power transmitting circuit and generate a magnetic field corresponding to the alternating-current signal; and
a secondary resonator according to claim 1 configured to receive the alternating-current signal by magnetically coupling to the primary resonator.
